(19) United States
(12) Patent Application Publication
(10) Pub. No.: US 2012/0239456 A1
(43) Pub. Date: Sep. 20, 2012

(54) CATEGORY ANALYSIS MODEL TO FACILITATE PROCUREMENT OF GOODS AND SERVICES

(75) Inventor: Richard D. JONES, Chandler, AZ (US)

(73) Assignee: BANK OF AMERICA CORPORATION, Charlotte, NC (US)

(21) Appl. No.: 13/489,186

(22) Filed: Jun. 5, 2012

Related U.S. Application Data
(63) Continuation-in-part of application No. 12/182,291, filed on Jul. 30, 2008, now abandoned.
(60) Provisional application No. 61/007,710, filed on Dec. 14, 2007.

(51) Int. Cl. G06Q 30/02; G06Q 10/08

(52) U.S. Cl. 705/7.31

(57) ABSTRACT

A category analysis model to facilitate strategic procurement is disclosed. The model can be created by receiving and arithmetically totaling numerical demand characteristics input for each of a plurality of goods and services, and receiving and arithmetically totaling numerical supply characteristics input for each of the plurality of goods and services. Supply and demand characteristics can be input by a user into software such as a spreadsheet, or interactively. The arithmetic totals of supply characteristics are graphically plotted against arithmetic totals of demand characteristics for each of the plurality of goods and services to produce a strategic procurement guide. The strategic procurement guide can then be displayed to a user. In example embodiments, the strategic procurement guide indicated that goods and services are in a clear strategic procurement category, a possible strategic procurement category, possible procurement category, and a clear procurement category.

### CROSS-REFERENCE TO RELATED APPLICATION

This application claims priority from co-pending, commonly owned non-provisional patent application Ser. No. 12/182,291, filed Jul. 30, 2008, which claims priority from commonly owned provisional patent application Ser. No. 61/007,710, filed Dec. 17, 2007, of which the entire disclosures are incorporated herein by reference.

### BACKGROUND

The strategic procurement of goods and/or services for a company or enterprise is of enormous importance and has a significant impact on the company's success in the marketplace. Despite this importance, it is often difficult to model characteristics of strategic procurement programs in use within an enterprise in a way that facilitates objective evaluation. Examination of such characteristics could help determine what type of procurement process the enterprise should use.

### SUMMARY

Embodiments of the invention provide a computer-implemented category analysis model that examines both demand side and supply side usage, quality and cost drivers. A thorough examination of supply and demand characteristics can aid in determining the degree to which the process of procurement should be transactional procurement or a more sophisticated strategic procurement process. A transactional procurement category can only be identified after the enterprise considers both supply and demand characteristics as they relate to the manner in which the commodity is consumed by the enterprise. For example, janitorial and custodial services for many companies are simple, transactional commodities. The primary areas of concern may be: (1) level of consistent cleanliness; (2) cost of labor and cleaning materials; (3) subcontractor employment practices; and (4) dependability. For most organizations, lower-level supply chain buyers can be assigned this category. Compare this to the needs for, as just on example, a worldwide banking enterprise. At a retail banking branch, the custodians must be given the keys to the bank, allowed access to all trash bins, counters, desks and offices in the facility and some cases, roam the facility when customers are in the area. Suddenly one realizes that thorough background investigations, residency status validation, and very tight access controls must be put in place. Not all janitorial services can be treated the same. In this example, the differences are obvious and clear, however the differences can be much more subtle in other categories of spend. And, when one places insufficient resources on a critical category, the results can be devastating.

In example embodiments of the invention, a method of facilitating strategic procurement includes arithmetically totaling numerical demand characteristics input for each of a plurality of goods and services, and arithmetically totaling numerical supply characteristics input for each of the plurality of goods and services. Supply and demand characteristics can be input by a user into software such as a spreadsheet, or input interactively. The arithmetic totals of supply characteristics are graphically plotted against arithmetic totals of demand characteristics for each of the plurality of goods and services to produce a strategic procurement guide. The strategic procurement guide can then be displayed to a user.

At the principle level of analysis, the assessment of demand characteristics tests the degree of control that the enterprise has on its consumption of the good or service. If the enterprise can very easily control its consumption, its overall risk is lower in this category. The assessment of supply characteristics tests the amount of exposure that the enterprise has to its suppliers when consuming the good or service. If the enterprise is highly dependent on single, oligopolistic supplier for the product, its overall risk is higher. In some embodiments, the demand characteristics can include fragmentation of spend, interest in supplier, durability of solution, uniqueness of form, confidence of solution, economic value of commitment, economics of switching, confidence with associates and factor in financials, and the supply characteristics can include specific market share, distributed organization of the industry, role of intermediaries, ownership of the solution, volatility of pricing, extension of reputation, degree of external procurement and interdependency of the relationship. After both the supply and demand characteristics have been reviewed, the strategic procurement guide provides a recommendation by indicating whether the commodity being assessed should be classified in one of four areas: (1) a clear strategic procurement category; (2) a possible strategic procurement category; (3) a possible transactional procurement category; and (4) a clear transactional procurement category. Using the earlier example related to janitorial and custodial services, for most industrial companies, this service would be a clear transactional procurement category. If however a national bank used the tool, the result would likely rate the service as a clear strategic procurement category.

In some embodiments, a system implementing the invention includes an instruction execution platform to arithmetically total supply and demand characteristics for each of a plurality of goods and services, and to graphically plot arithmetic totals of the supply characteristics against arithmetic totals of the demand characteristics to produce the strategic procurement guide. Data set storage can be functionally connected to the instruction execution platform to store data sets of demand and supply characteristics and strategic procurement guides. The instruction execution platform and the data set storage can be connected by a network. Computer program code instructions in combination with the hardware of the instruction execution platform can be used to implement features and functions of embodiments of the invention.

### BRIEF DESCRIPTION OF THE DRAWINGS

FIG. 1 illustrates a spreadsheet input form for demand characteristics as might be used with at least some embodiments of the present invention.

FIG. 2 illustrates a spreadsheet input form for supply characteristics as might be used with at least some embodiments of the present invention.

FIG. 3 is a screen shot of a strategic procurement guide as might be displayed to a user with at least some embodiments of the present invention.

FIG. 4 illustrates one embodiment of a method of the present invention in flowchart form.

FIG. 5 is a screen shot of an input screen that might be used to input values into the category analysis model according to some embodiments of the invention.

FIG. 6 is a flowchart that illustrates a method of an embodiment of the invention in which the input screen of FIG. 5 is used.

FIG. 7 is a system block diagram according to at least one example embodiment of the invention.

### DETAILED DESCRIPTION OF THE INVENTION

The following detailed description of embodiments refers to the accompanying drawings, which illustrate a specific embodiment of the invention. Other embodiments do not depart from the scope of the present invention.

As will be appreciated by one of skill in the art, the present invention may be embodied as a method (including a business process), article, system, computer program product, or a combination of the foregoing. Any suitable computer usable or computer-readable medium may be utilized for a computer program product to implement all or part of the invention. The computer usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires; a tangible storage medium such as a portable computer diskette, a hard disk, a random access memory (RAM), a read-only memory (ROM), an erasable programmable read-only memory (EPROM or Flash memory), a portable compact disc read-only memory (CD-ROM), an optical storage device; or transmission media such as those supporting the Internet or an intranet.

Computer program code for carrying out operations of the present invention or for assisting in the carrying out of a method according to an example embodiment of the invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages. In the specific example embodiments presented herein, a tool for organizing and capturing strategic procurement information for the category analysis model is implemented via a spreadsheet program such as Microsoft Excel™.

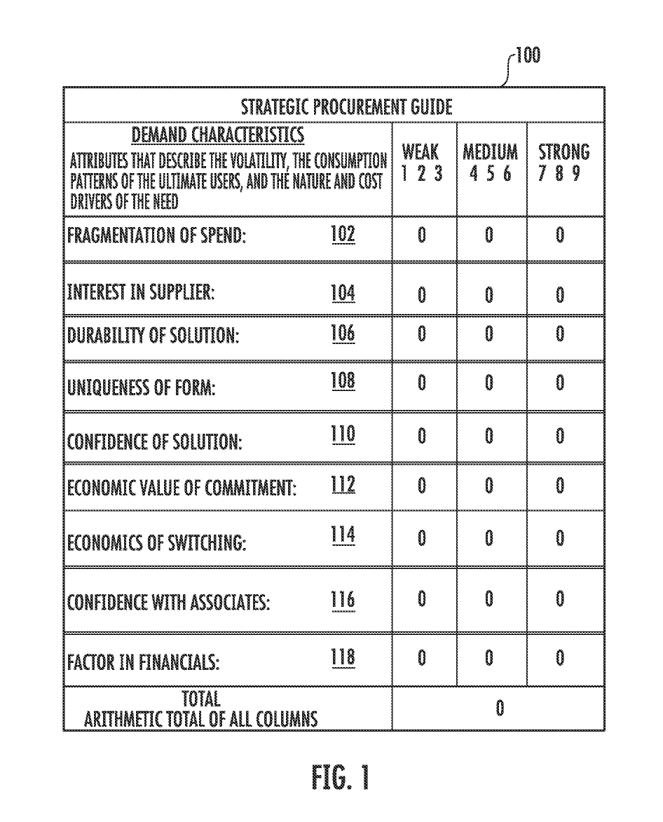

Example embodiments of the present invention include an internal category analysis that examines both demand-side and supply-side usage, quality, and cost drivers for procurement by a company or enterprise. FIG. 1 highlights this technique. The characteristics of supply dictate the degree of risk and exposure the company will experience based on such factors as continuity of supply, cost volatility, implicit supplier leverage, risk, and protection of information. The characteristics of demand dictate the degree of control the company possesses over need to consume based on such factors as the uniqueness of its needs, amount of consumption, and the internal patterns of consumption. A thorough examination of these characteristics can aid in determining the degree to which the process of procurement of goods and services within a company should be by transactional procurement or a more sophisticated strategic procurement process.

For each category of goods or services procured by the company, the goods or services are assessed with respect to both supply characteristics and demand characteristics. Input can be solicited regarding all of these characteristics. The extent to which each specific category of goods or services as procured by the company possesses each characteristic is documented, for example, on a scale of 1 to 9, 1 denoting the characteristic being the weakest for a category of good or service, and 9 denoting the characteristic being the strongest. Categories of goods and services for a typical enterprise might include such items as: telemarketing services, forms design and printing, reprographics, mail services, records storage, advertising, office supplies, and market research services.

FIG. 1 illustrates a spreadsheet input form, 100, for demand characteristics. The definition of each demand characteristic is presented to guide the evaluators, as follows:
FRAGMENTATION OF SPEND 102: There are many internal consumers of the product or service. Usage spans several business units or users, and may be relatively equal in consumption levels among the users. Users may not be aware of other consumers of the product or service, but if they are cognizant, little has been done to combine and leverage the spend. (A “YES” response is scored as STRONG.)
INTEREST IN SUPPLIER 104: The ultimate consumer of the product or service is not indifferent to the supplier. For example, if the supplier is a distributed supplier, a small business, or is a relative newcomer to the market, the ultimate consumer has a legitimate and great need to know since this will influence business unit or user support. The ultimate consumer is more highly focused on the provider then on other characteristics of the consumed product. (A “YES” response is scored as STRONG.)
DURABILITY OF SOLUTION 106: The extent to which the time over which the product or service will be consumed spans an extended period of time—beyond twelve (12) months from initial use through a continuous or regular consumption period. (Score the attribute STRONG if the timeframe for consumption is much longer than a twelve-month period.)
UNIQUENESS OF FORM 108: Key features and measurable/observable facets of the product or service to be consumed will be completely customized to match the multi-dimensional needs of the ultimate consumer. The product or service uniqueness is much greater than a collection of stand-alone common goods or services that are combined to meet the need. Individual components that comprise the solution are unique and interrelated. (A highly configurable solution that will be uniquely tooled to meet the predefined and measured needs of the ultimate consumer would score STRONG.)
CONFIDENCE OF SOLUTION 110: The product or service being consumed requires that the ultimate consumer entrust the provider with information and/or assets of a highly proprietary, sensitive or personal nature. The exchange of the information and/or assets between the parties of the agreement is highly protected, monitored, and closely managed to prevent interception by parties foreign to the agreement. The exchanged information and/or assets do not degrade in value or sensitivity over time. (A STRONG score would be characterized by a continuous stream of exchanges of a product or service requiring significant risk reduction/mitigation efforts, broad and deep non-disclosure agreements, data encrypting and mutual senior-level approval by all involved parties.)
ECONOMIC VALUE OF COMMITMENT 112: On an annualized basis, the financial commitment by the ultimate consumer of the product or service is in excess of some threshold. For at least some large corporations, a threshold of around $2.2 million US will work. In this case, the degree to which the commitment exceeds the $2.2 million threshold is a measure of the relative strength of the attribute. (Score the attribute STRONG if the financial commitment by the ultimate consumer on an annualized basis far exceeds $2.2 million US.)
ECONOMICS OF SWITCHING 114: Due to the degree and complexity of the cross-partner interdependencies required to provide the product or service to the ultimate consumer or intermediary of the ultimate consumer, the economics of changing partners frequently is prohibitively high. A frequency threshold of 36 months works for at least some large corporations. (Score the attribute STRONG if the economics of switching dictate that any planned change of providers extends beyond 36 months due solely to the financial costs and resource commitment needed to ensure manageable risk and smooth transfer.)
CONFIDENCE WITH ASSOCIATES 116: The product or service is directly consumed by the majority of the company's associates (employees) and/or family members of associates and evidence indicates deference to the provider and the strength of the relationship between the company and the provider. The provider may possess personal or confidential information about the association after the product or service has been consumed; therefore, associates prefer a long-term, mutually beneficial relationship between the company and the provider. (Score the attribute STRONG if associates have a high degree of personal closeness with the provider of goods or services.)
FACTOR IN FINANCIALS 118: The product or service being consumed is directly linked to the revenue-generating capability of the company and is a major factor in determining both short- and long-term organizational profitability. It can be reasonably concluded that a full two-week interruption in the stream of consumption of the product or service will jeopardize the company's ability to meet its quarterly financial commitments. (Score the attribute STRONG if there exits a direct measurable and material link between the product or service and the short-term profitability of the company.)

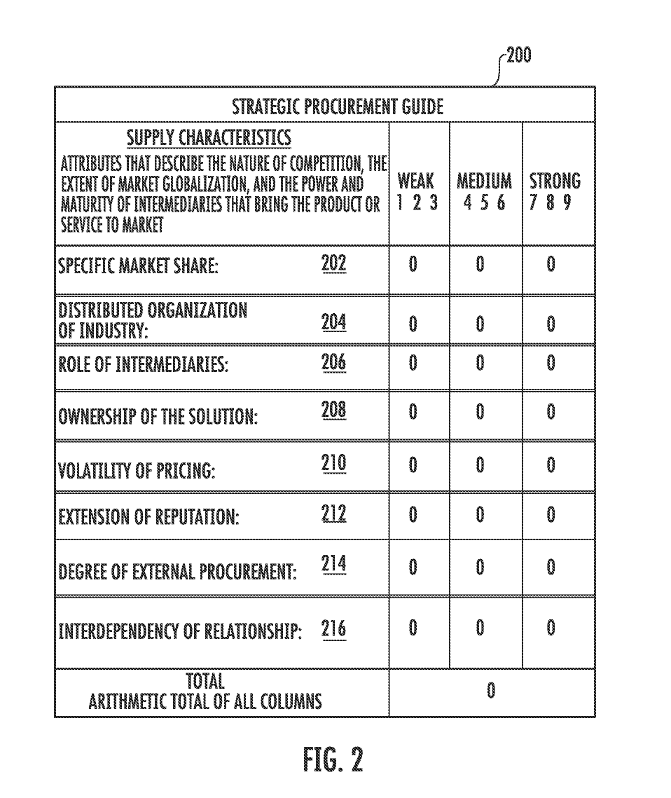

FIG. 2 illustrates a spreadsheet input form 200 for supply characteristics. Evaluators use the form to rate each characteristic for a given category of goods or services. The definition of each supply characteristic is presented to guide the evaluators, as follows:
SPECIFIC MARKET SHARE 202: The product or service provider is of sufficient market size and behaves in a manner that strongly indicates that it clearly realizes there are few viable alternative providers or substitutes that the company can consider in both the short and long term. (The specific market share behaviors are clearly evident and can be described in detail) The supplier may or may not operate in a federally regulated industry. (A “YES” response is scored as STRONG.)
DISTRIBUTED ORGANIZATION OF INDUSTRY 204: The providers of the product or service obtain components and/or services from emerging cost-saving regions and/or they directly compete with providers operating in these regions. Information needed to fulfill the ultimate consumer's needs may be shared across borders with other dominant regions on a routine basis. Although the incumbent provider may not operate worldwide, it is clear that alternative suppliers exist in these external regions. (A “YES” response is scored as STRONG.)
ROLE OF INTERMEDIARIES 206: Many providers of the product or service consumed by the ultimate consumer operate through a network of supply chain partners. The partners assume various duties such as aggregating demand, distributing, acquiring, warehousing, forecasting and planning. Partners also regularly share information with other partners to ensure proper fulfillment of the ultimate consumer's needs. (Score the attribute STRONG if intermediaries have a distinct role in the supply chain. The stronger the role of the intermediary, the STRONGER the attribute should be scored.)
OWNERSHIP OF THE SOLUTION 208: The provider of the product or service does not legally exchange ownership of the solution during the consumption process. Agreements between the parties allow for the use of the solution by the ultimate consumer or the line-of-business partner through a license, usage or rental agreement. The intellectual property is embodied in the solution and is protected by both parties in the relationship. (A “YES” response is scored as STRONG.)
VOLATILITY OF PRICING 210: Worldwide market competition, technology and raw material content are key economic factors impacting the cost and pricing of the product or service used by the ultimate consumer. The nature of these factors on all providers of the product or service is such that the historical and future pricing is expected to be volatile, inflationary or deflationary over the time horizon of consumption. (A “YES” response is scored as STRONG.)
EXTENSION OF REPUTATION 212: The nature of the relationship the company has with the provider of the product or service or the branded qualities of it are such that customers and/or associates directly associate the product or service with the company. There is no distinction between the company and the product or service being consumed by the company's customers. (A “YES” response is scored as STRONG. The less visible the provider, the STRONGER the scoring of this attribute.
DEGREE OF EXTERNAL PROCUREMENT 214: The solution sought by the ultimate consumer is to engage a provider in ongoing management and continuous improvement of activities associated with a part or with the whole of standard business functions (e.g., personnel, marketing, payroll), infrastructure and/or operating processes). The agreement with the provider includes a fixed-limit contractual arrangement covering the transfer of business processes and possible transfer of assets and people. (A “YES” response is scored as STRONG. The greater the overall breadth of the transferred routines, the STRONGER the scoring of this attribute.)
INTERDEPENDENCY OF RELATIONSHIP 216: One or more of the providers of the product or service are medium to large customers of the company wherein their ongoing financial commitment to the company is significantly larger than the value of the annual consumption with the provider. In addition, the potential provider may have a strong personal relationship with a member of the company's board of directors or major shareholders. (Score the attribute STRONG at level 7 if the financial commitment by the potential provider on an annualized basis is greater than a specific threshold. For a large U.S. corporation $20MM can be used. Score the attribute higher if the financial commitment is significantly greater then $20MM US. Score the attribute MEDIUM if there is a strong personal link between the company's board of directors or major shareholders & the potential provider.)

It should be noted that a spreadsheet program according to this example simply takes the arithmetical total of all columns for the supply page and the arithmetical total of all columns of the demand page, where each evaluator enters a single number between 1 and 9 for each characteristics. The input cells are formatted in three columns only for convenience in viewing the input as it s being entered.

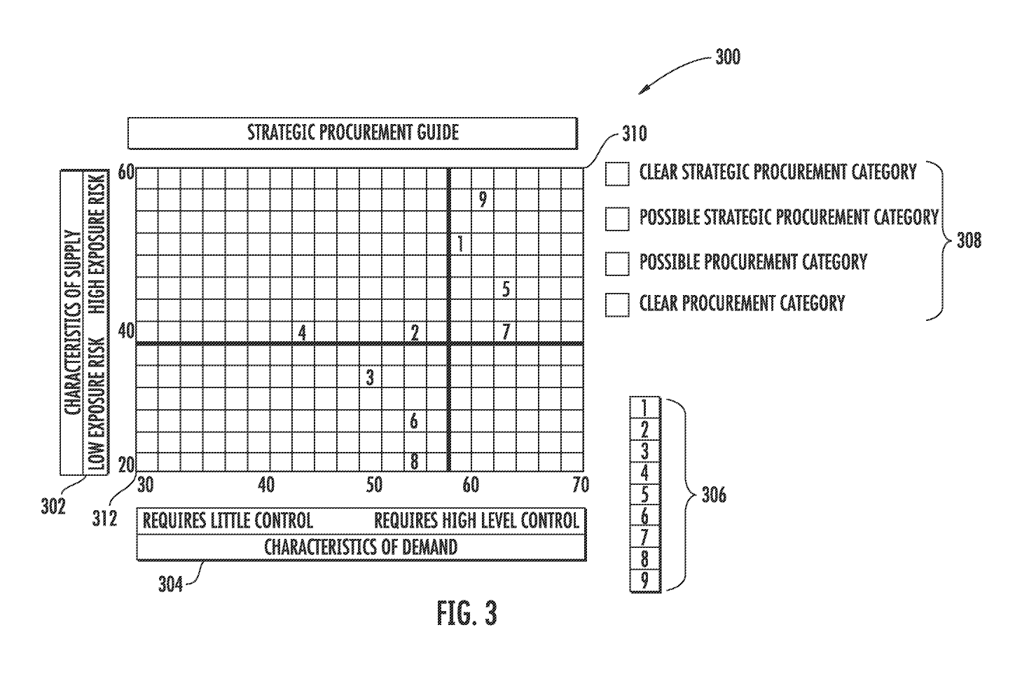

A program that accepts input as shown in FIGS. 1 and 2 can be designed to present an analysis based on the input as shown in FIG. 3. Matrix-based report 300 shown in FIG. 3 can be referred to as a “strategic procurement guide.” Each category of goods and services is plotted on the grid shown in FIG. 3. The supply value is on vertical axis 302 and the demand value is on horizontal axis 304. In this particular example, categories of procured goods and/or services are assigned numbers 1-9 and key 306 lists the categories in text (not shown) so that they can be identified. The grid is color-coded according to the key 308 in FIG. 3. Specifically, categories of goods and services that tend to plot to the upper right 310 of the grid are appropriate for strategic procurement, that is, procurement of these goods and services should be managed with a higher-level of involvement from procurement professionals. Procurement of goods and services that tend to plot to the lower left 312 in the grid are appropriate for routine procurement activities. Such a display can facilitate discussions and debate within the enterprise regarding how to most effectively manage procurement activities.

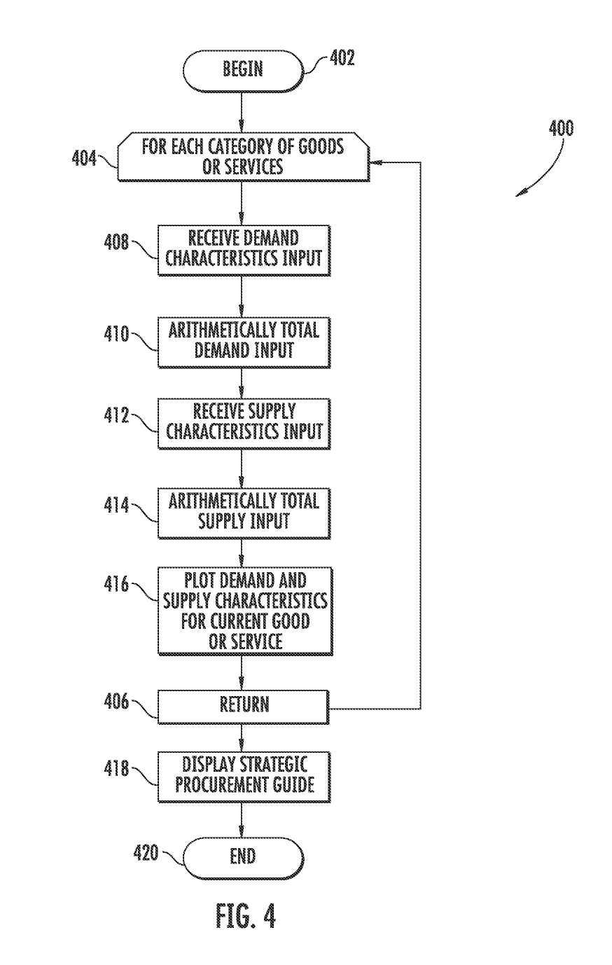

FIG. 4 is a flowchart of a high-level process according to at least some computer-implemented embodiments of the invention. Like most flowcharts, FIG. 4 illustrates process 400 as a series of process or sub-process blocks. Process 400 begins at block 402. At block 404, a loop is set up with return block 406 and all the blocks in between indicate processes or sub-processes that are performed for each category of goods or services until all categories have been addressed. At block 408 demand characteristics input is received. This input is arithmetically totaled at block 410. Likewise, at block 412 supply characteristics input is received. This input is arithmetically totaled at block 414. Demand and supply characteristics are plotted for the current good or service being input at block 416. Processing returns at block 406 as long as there is another good or service to categorize. Once input has been received, totaled and plotted for all goods and services, the strategic procurement guide is displayed to the user at block 418. Process 400 ends at block 420.

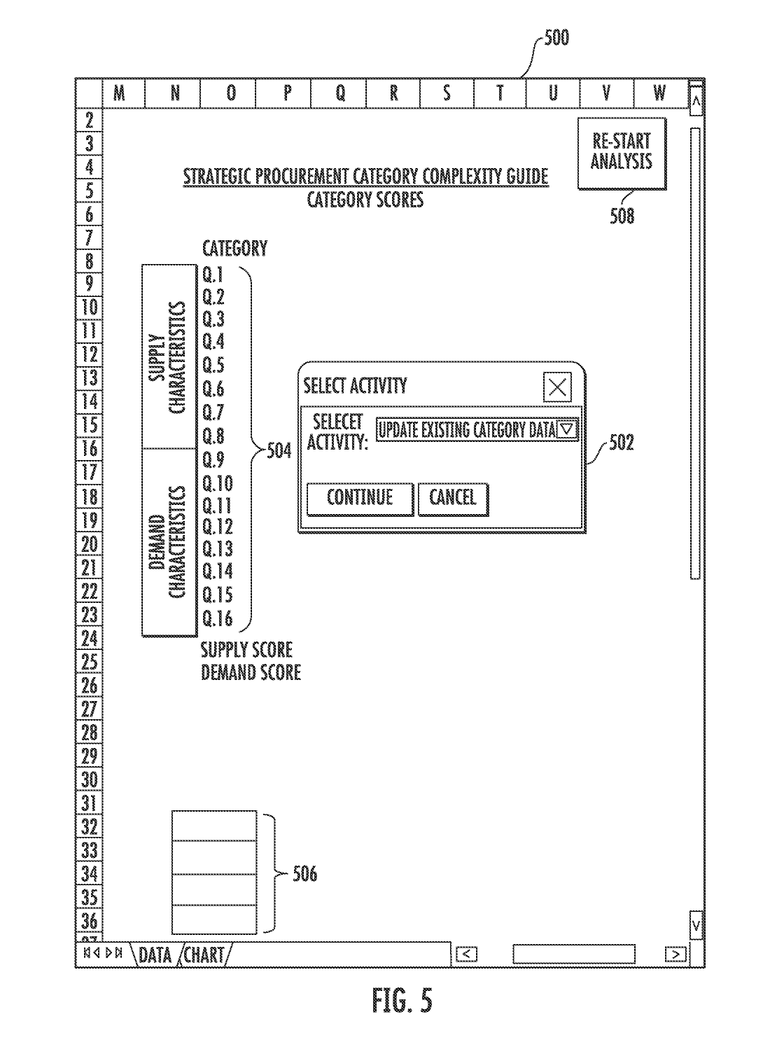

FIG. 5 presents a screen shot of an input screen for another computer-implemented embodiment of the present invention. Screen 500 is for an implementation where a macro queries the user in an interactive fashion via dialog box 502. Answers are updated in screen area 504 and displayed, as they are input. Color key 506 lists colors that can be used to highlight the data input. Dialog box 502 includes a drop-down box where a user can select various input modes, such as one to delete category data, start a new analysis, or modify existing category data. Button 508 is clicked to run a new analysis, or re-run an analysis with new data input, and its screen legend can be made to change accordingly.

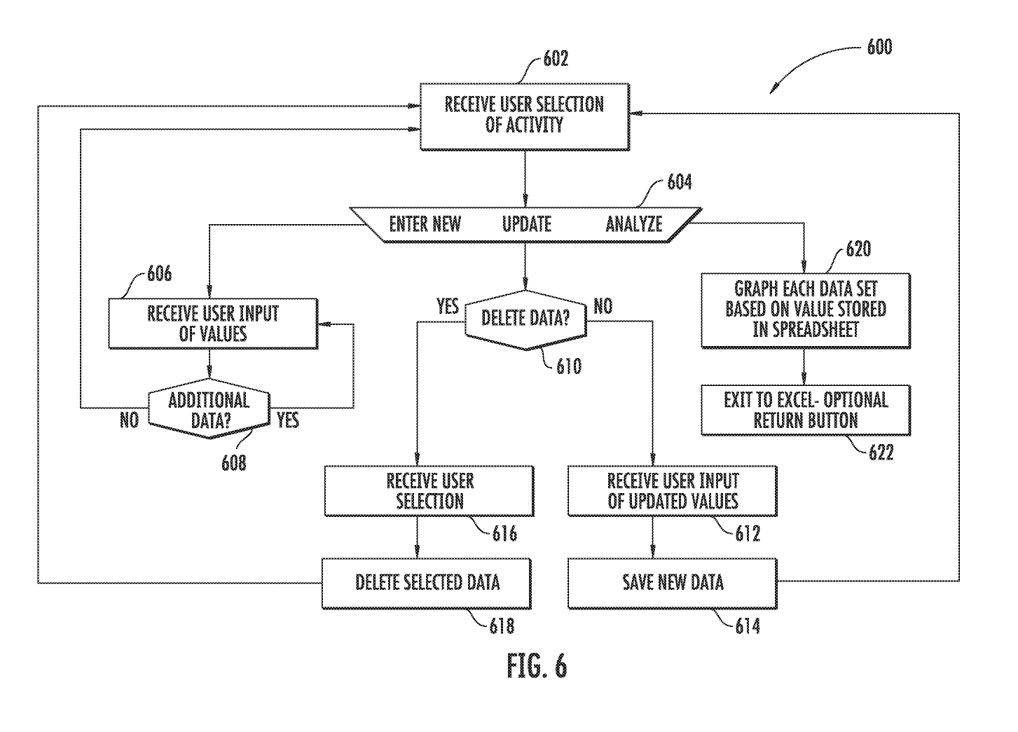

FIG. 6 is a flowchart illustrating an example computer-implemented process for an embodiment of the invention that uses a graphical interface like that shown in FIG. 5 to receive supply and demand characteristics interactively. Process 600 begins at block 602 when the user makes an input selection. At block 604, processing branches depending on the selection. The system is either set up for entry of new data, updating of existing data, or analysis. When new data is to be entered, user input values are received at block 606 as long as there is additional data to be input at block 608. Once all data has been input, processing returns to bock 602 as shown.

Still referring to FIG. 6, if the update option has been selected, processing branches at block 604 to block 610 where further input determines whether data is to be deleted or updated. If it is to be updated, new data input is received at block 612, the data is saved in storage at block 614, and processing returns to block 602. If data is to be deleted, the user selects the data at block 616, the selected data is deleted at block 618, and processing returns again to block 602 for another user selection. Finally, if the analyze data button was pressed at block 602, processing branches at block 604 to block 620, where each data set is graphed based on the values stored in the spreadsheet. The program or macro implementing this embodiment of the invention exits to the spreadsheet at block 622. Optionally, a return button can be displayed.

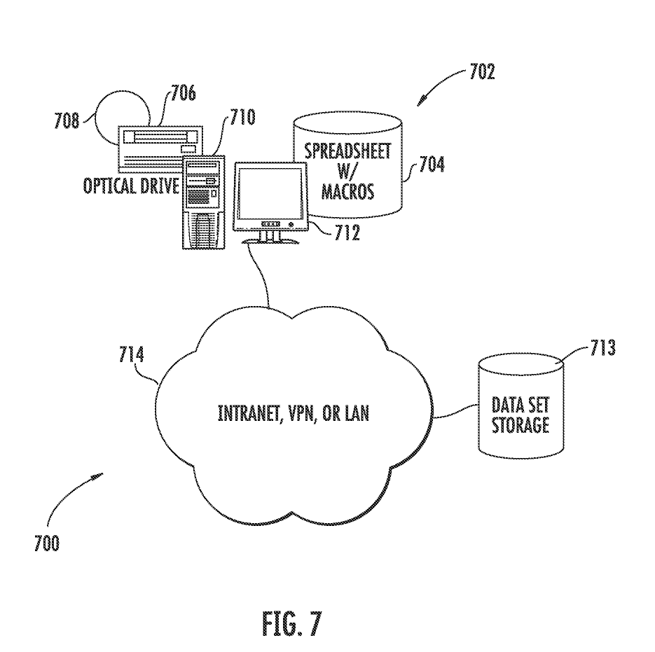

FIG. 7 illustrates a typical operating environment for embodiments of the present invention. FIG. 7 actually illustrates two alternate embodiments of a system implementing the invention. Computer system 702 can be a workstation or personal computer. System 702 can be operated in a “stand-alone” mode, in which a user enters all data and the data is stored only locally. The system includes a fixed storage medium, illustrated graphically at 704, for storing spreadsheet or other programs, and/or macros, which enable the use of an embodiment of the invention. In a spreadsheet implementation of the invention, these include the spreadsheet program and any macros or plug-ins, which are necessary to customize the spreadsheet program to implement an embodiment of the invention. Otherwise, these can include application programs or an application program, which implements the invention. In this particular example, an optical drive, 706, is connected to the computing platform for loading the appropriate computer program product into system 702 from an optical disk, 708. The computer program product includes a computer program code with instructions for carrying out the methods of the invention.

Instruction execution platform 710 can execute the appropriate instructions and display appropriate screens on display device 712. These screens can include a user input screen, which is operable to receive demand, and supply characteristics input. FIG. 7 also illustrates another embodiment of the invention in which case the system 700, which is implementing the invention, includes a connection to data set storage 713. Data sets can include previously entered supply and demand characteristics data, as well as previously generated strategic procurement guides. The connection to the data set storage or appropriate databases can be formed in part by network 714, which can be an intranet, virtual private network (VPN) connection, local area network (LAN) connection, or any other type of network resources, including the Internet.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, action, or portion of code, which comprises one or more executable instructions or actions for implementing the specified logical function(s). It should also be noted that, in some alternative implementations, the functions noted described herein may occur out of the order presented, depending upon the functionality involved. It will also be noted that each block of the block diagrams and/or flowchart illustrations, and combinations of blocks in the block diagrams and/or flowchart illustrations, can be implemented by special purpose hardware-based systems or operators which perform the specified functions or acts.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Additionally, comparative, quantitative terms such as “above”, “below”, “less”, “greater”, are intended to encompass the concept of equality, thus, “less” can mean not only “less” in the strictest mathematical sense, but also, “less than or equal to.”

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A computer implemented method of facilitating strategic procurement, the method comprising:
receiving and arithmetically totaling, via a computing device processor, numerical demand characteristics input for each of a plurality of categories of goods and services, wherein the demand characteristics define a degree of control that an entity possesses over a need to consume based on uniqueness of requirements, amount of consumption and internal patterns of consumption;
receiving and arithmetically totaling, via a computing device processor, numerical supply characteristics input for each of the plurality of categories of goods and services, wherein the supply characteristics define a degree of risk and exposure that the entity incurs based on continuity of supply, cost volatility, implicit supplier leverage, and protection of information;
plotting, via a computing device processor, the plurality of categories of goods and services on a two-dimensional graph, wherein a first axis of the graph represents the arithmetic total of supply characteristics and a second axis of the graph represents the arithmetic total of demand characteristics for a category of goods and services;
generating, via a computing device processor, a strategic procurement guide that includes the plotted graph, wherein the plotted graph defines a first quadrant that is configured to plot categories of goods and services as a clear strategic procurement candidate, a second quadrant configured to plot categories of goods and services as a possible strategic procurement candidate, a third quadrant configured to plot categories goods and services as a possible procurement candidate and a fourth quadrant configured to plot categories of goods and services as a clear procurement candidate; and
displaying, via a computing device user interface, the strategic procurement guide to a user.

2. The method of claim 1 wherein the numerical demand characteristics comprise fragmentation of spend, interest in supplier, durability of solution, uniqueness of form, confidence of solution, economic value of commitment, economics of switching, confidence with associates and factor in financials.

3. The method of claim 1 wherein the numerical supply characteristics comprise specific market share, distributed organization of the industry, role of intermediaries, ownership of the solution, volatility of pricing, extension of reputation, degree of external procurement and interdependency of the relationship.

4. The method of claim 2 wherein the numerical supply characteristics comprise specific market share, distributed organization of the industry, role of intermediaries, ownership of the solution, volatility of pricing, extension of reputation, degree of external procurement and interdependency of the relationship.

5. The method of claim 3 wherein the numerical demand characteristics comprise fragmentation of spend, interest in supplier, durability of solution, uniqueness of form, confidence of solution, economic value of commitment, economics of switching, confidence with associates and factor in financials.

6. A non-transitory computer-readable storage medium having computer program code for facilitating strategic procurement embodied thereon, the computer program code comprising:
instructions for receiving and arithmetically totaling numerical demand characteristics input for each of a plurality of categories of goods and services, wherein the demand characteristics define a degree of control that an entity possesses over a need to consume based on uniqueness of requirements, amount of consumption and internal patterns of consumption;
instructions for receiving and arithmetically totaling numerical supply characteristics input for each of the plurality of categories of goods and services, wherein the supply characteristics define a degree of risk and exposure that the entity incurs based on continuity of supply, cost volatility, implicit supplier leverage, and protection of information;
instructions for plotting the plurality of categories of goods and services on a two-dimensional graph, wherein a first axis of the graph represents the arithmetic total of supply characteristics and a second axis of the graph represents the arithmetic total of demand characteristics for a category of goods and services instructions for generating a strategic procurement guide that includes the plotted graph, wherein the plotted graph defines a first quadrant configured to plot categories of goods and services as a clear strategic procurement candidate, a second quadrant configured to plot categories of goods and services as a possible strategic procurement candidate, a third quadrant configured to plot categories of goods and services as a possible procurement candidate and a fourth quadrant configured to plot categories of goods and services as a clear procurement candidate; and
instructions for displaying the strategic procurement guide to a user.

7. The computer-readable storage medium of claim 6 wherein the numerical demand characteristics comprise fragmentation of spend, interest in supplier, durability of solution, uniqueness of form, confidence of solution, economic value of commitment, economics of switching, confidence with associates and factor in financials.

8. The computer-readable storage medium of claim 6 wherein the numerical supply characteristics comprise specific market share, distributed organization of the industry, role of intermediaries, ownership of the solution, volatility of pricing, extension of reputation, degree of external procurement and interdependency of the relationship.

9. The computer-readable storage medium of claim 7 wherein the numerical supply characteristics comprise specific market share, distributed organization of the industry, role of intermediaries, ownership of the solution, volatility of pricing, extension of reputation, degree of external procurement and interdependency of the relationship.

10. The computer-readable storage medium of claim 8 wherein the numerical demand characteristics comprise fragmentation of spend, interest in supplier, durability of solution, uniqueness of form, confidence of solution, economic value of commitment, economics of switching, confidence with associates and factor in financials.

11. A system for facilitating strategic procurement comprising:
a computing device having a memory and a processor in communication with the memory;
an instruction execution platform stored in the memory, executable by the processor and configured to arithmetically total numerical demand characteristics and supply characteristics input for each of a plurality of categories of goods and services, plot the plurality of categories of goods and services on a two-dimensional graph, wherein a first axis of the graph represents the arithmetic total of supply characteristics and a second axis of the graph represents the arithmetic total of demand characteristics for a category of goods and services and to generate a strategic procurement guide that includes the plotted graph, wherein the plotted graph defines a first quadrant configured to plot categories of goods and services as a clear strategic procurement candidate, a second quadrant configured to plot categories of goods and services as a possible strategic procurement candidate, a third quadrant configured to plot categories of goods and services as a possible procurement candidate and a fourth quadrant configured to plot categories of goods and services as a clear procurement candidate; and
data set storage functionally connected to the instruction execution platform to store data sets of demand and supply characteristics and strategic procurement guides, wherein the demand characteristics define a degree of control that an a entity possesses over a need to consume based on uniqueness of requirements, amount of consumption and internal patterns of consumption and the supply characteristics define a degree of risk and exposure that the entity incurs based on continuity of supply, cost volatility, implicit supplier leverage, and protection of information.

12. The system of claim 11 further comprising a network interconnecting the instruction execution system and the data set storage.
